(19) United States
(12) Patent Application Publication
(10) Pub. No.: US 2024/0418835 A1
(43) Pub. Date: Dec. 19, 2024

(54) Multiplane scanner and method for detecting objects

(71) Applicant: SICK AG, Waldkirch (DE)

(72) Inventors: Hannes KLINKE, Waldkirch (DE); Gerold FEISE, Waldkirch (DE)

(21) Appl. No.: 18/743,298

(22) Filed: Jun. 14, 2024

(30) Foreign Application Priority Data
Jun. 15, 2023 (EP) 23179534.5

(51) Int. Cl. G01S 7/481; G01S 7/4912; G01S 17/32

(52) U.S. Cl. CPC G01S 7/4817; G01S 7/4811; G01S 7/4918; G01S 17/32

(57) ABSTRACT

A multiplane scanner includes a light transmitter for transmitting a light beam into a monitored zone, a light receiver for receiving the light beam reflected by objects in the monitored zone, an evaluation unit for evaluating a received signal of the light receiver, and a polygonal mirror wheel that is rotatable about a first axis of rotation for a periodic deflection of the light beam. The polygonal mirror wheel has a plurality of mirror facets arranged in ring form and tilted at least partly with respect to one another with respect to the first axis of rotation to scan an angular section of the monitored zone multiple times at different heights per revolution of the polygonal mirror wheel. A beam deflection unit sets an angle of incidence of the light beam on the mirror facets and is arranged between the light transmitter and the polygonal mirror wheel.

The invention respectively relates to a multiplane scanner and to a method for detecting objects in a monitored zone having a plurality of planes arranged above one another.

Scanners are used for a variety of monitoring and measuring tasks. For this purpose, a light beam scans a zone and evaluates the reflected light. In order also to acquire information on object distances, contours, or profiles, typically not only the present of objects is determined, but rather simultaneously also their distance. Such distance-measuring laser scanners or LiDAR (light detection and ranging) scanners work in accordance with a time of flight principle in which the time of flight from the scanner into the scene and back is measured and distance data are calculated using the speed of light.

Two types of time of flight methods are widespread. In phase-based methods, the light transmitter modulates the light beam and the phase between a reference and the received light beam light beam is determined. Pulse-based methods impart a significant pattern onto the light beam, for example a narrow pulse of only a few nanoseconds duration, and determine the reception time of this pattern. In a generalization called a pulse averaging method, a plurality of pulses or a pulse sequence is transmitted and the received pulses are statistically evaluated.

Furthermore, frequency modulated continuous wave (FMCW) LiDAR scanners are known as distance measuring laser scanners. The principles of FMCW LiDAR technology are, described, for example, in the scientific publication “Linear FMCW Laser Radar for Precision Range and Vector Velocity Measurements” (Pierrottet, D., Amzajerdian, F., Petway, L., Barnes, B., Lockard, G., & Rubio, M. (2008). Linear FMCW Laser Radar for Precision Range and Vector Velocity Measurements. MRS Proceedings, 1076, 1076-K04-06. doi:10.1557/PROC-1076-K04-06) or the doctoral thesis “Realization of Integrated Coherent LiDAR” (T. Kim, University of California, Berkeley, 2019. https://escholarship.org/uc/item/1d67v62p).

Unlike LiDAR scanners based on a time of flight measurement of laser pulses or laser range finders, an FMCW LiDAR scanner does not transmit any pulsed transmitted light beams into a monitored zone, but rather continuous transmitted light beams that have a predetermined frequency modulation, that is a time variation of the wavelength of the transmitted light, during a measurement, that is a time-discrete scanning of a measurement point in the monitored zone. The measurement frequency of a total frame that can comprise 100,000 measurement points or more is here typically in the range from 10 to 30 Hz. The frequency modulation can be formed, for example, as a periodic upward and downward modulation. Transmitted light reflected by measurement points in the monitored zone has, in comparison with irradiated transmitted light, a time offset corresponding to the time of light that depends on the distance of the measurement point from the sensor and is accompanied by a frequency shift due to the frequency modulation. Irradiated and reflected transmitted light are coherently superposed in the FMCW LiDAR sensor, with the distance of the measurement point from the sensor being able to be determined from the superposition signal. The measurement principle of coherent superposition inter alia has the advantage in comparison with pulsed or amplitude modulated incoherent LiDAR measurement principles of increased immunity with respect to extraneous light from, for example, other optical sensors/sensor systems or the sun.

Known laser scanners have a rotating mirror or a polygonal wheel that rotate about an axis of rotation to periodically scan a monitored plane or a segment of a two-dimensional monitored plane. There is, however, the desire in a number of applications to not only detect the environment in a single plane. This in particular applies in mobile applications, for instance with automated guided vehicles (AGVs), where there is a demand to recognize the floor with edges and steps just as objects that project into the travel zone at different heights. Another application is the monitoring and classification of vehicles, for example on highways or at automatic detection points.

The prior art Is familiar with three-dimensional scanners in which the sensor as a whole or the rotating mirror is additionally periodically tilted. However, this requires very complex and/or expensive constructions in all cases. It is frequently sufficient if it is not a whole spatial zone that can be monitored, but rather only some planes layered over one another.

A possibility of achieving such a multiplane scanning comprises using mirror wheels instead of a simple polygonal wheel as the beam deflection unit whose mirror facets have different inclinations or tilts with respect to the axis of rotation of the polygonal wheel. The scanning angle area is admittedly reduced to typically less than 100° by the use of a polygonal wheel, but the monitored zone is in turn scanned multiple times at different heights per revolution due to the inclined mirror facets. The light beam here extends on a trajectory that generates scan planes disposed above one another at different heights in the monitored zone.

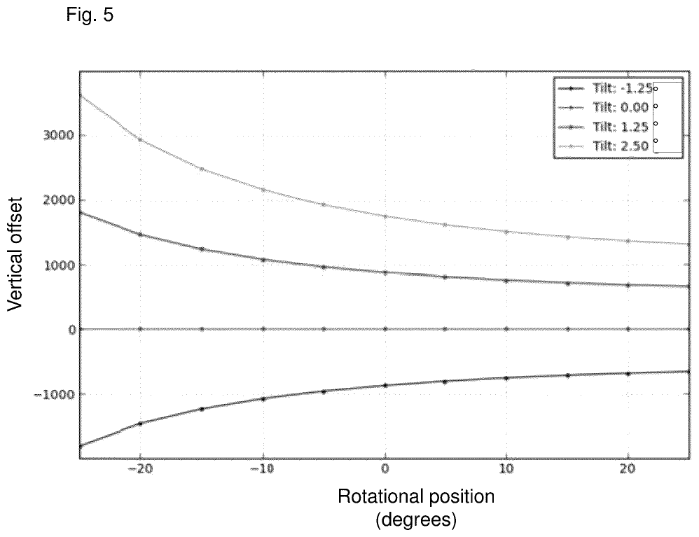

However, such mirror wheels have the disadvantage that the scan planes are distorted due to the different angle of incidence of the scan beam on the mirror facets in the course of the rotational movement provided that a feed angle of greater than 0° (that is not coming directly from the front) is selected, which is almost always the case. This is illustrated in FIG. 5 in which a vertical offset is applied over the angle of rotation of the raster mirror wheel for a plurality of planes. In other words, the scan lines are shown on a target plane in the monitored zone that are generated by a plurality of differently inclined mirror facets.

As can be recognized in FIG. 5, only the middle line of a mirror facet is a straight line without a tilt. It is now not problematic that the other lines are curved. This is due to the fact that a multiplane scanner strictly speaking does not detect a plurality of planes, but rather cone surface areas. Scan lines projected onto a target plane are therefore radially curved with inclined mirror facets. The difference from a plane is not all that relevant to this extent since the cone angle is very large due to the small tilt angle.

The fact is rather disturbing that the scan lines are asymmetrical with respect to the middle line at a rotational position of 0°. The vertical angular resolution with positive rotational positions is therefore better than with negative rotational positions and thus detection zones belonging to a facet are also no longer planar in a polar observation on a conical surface: The vertical resolution power depends in an unwanted manner on the angular position of the raster mirror wheel.

Inclined mirror surfaces therefore produce distorted, parabolic beam deflections, in particular in the far zone, that make an equidistant scan in the far zone more difficult. If the parabolic curves diverge to far from one another, it is possible that the marginal zones are outside a region of interest (ROI). In the extreme case, the beams extend outside the monitored zone and measurement time is wasted in which no sensible output is generated. In addition, the point density in the ROI of the monitored zone is reduced.

DE 36 02 008 A1 discloses an optical scan device having a mirror wheel. The mirror facets of this mirror wheel are differently curved. A mirror wheel having six mirror surfaces is given as a specific example, with a respective pair of diametrically opposed mirror surfaces being planar, concave, and convex. The scan device comprises evaluation electronics that respond to the sharpness of the received light spot and only evaluates the signal emanating from the sharpest scanning light surface.

US 2013/0076852 A1 deals with a scanning system that generates parallel scan lines on an image plane by a light beam. A raster polygonal mirror is provided for this purpose whose mirror facets each have a different tilt angle. To compensate curvatures of the scan lines generated by the mirror surfaces, a lens system of five single lenses is used in the specific example that compensates the distortion.

EP 1 965 225 A2 discloses various variants of additionally tilting the rotating mirror of a laser scanner to vary the scan plane and thereby to increase the field of vision.

It is known from EP 2 983 030 A2 to compensate the distortion of the scan planes addressed above in the most varied manners. On the one hand, by static measures such as a shaping of the mirror facets as free-form surfaces having a compensating contour or of a front screen having a plurality of segments corresponding to the scan planes disposed above one another and having a compensating contour. Dynamic correction possibilities such as a dynamic tilting of the mirror facets synchronized with the rotation of the mirror wheel or a displacement of the light transmitter and/or light receiver are furthermore named. The aim is in particular to achieve a constant vertical angular resolution over the different scan planes. This means that the above-mentioned scan lines are preferably formed in parallel on a target plane that is generated by the differently inclined mirror facets.

Overall, the known techniques are directed to achieve a scan of a monitored zone that is as uniform as possible. In many cases, however, a flexible, application-dependent scan of the monitored zone is desirable, for example with respect to the number, density, and position, as well as the shape and inclination of scan planes or scan lines. The light beam should therefore be guided on a trajectory in the monitored zone that is as flexible as possible.

It is therefore the object of the invention to improve the monitoring of a 3-dimensional monitored zone using a multiplane scanner.

This object is satisfied by a multiplane scanner and by a method for detecting objects in a monitored zone having a plurality of planes arranged above one another in accordance with the respective independent claim.

Like the known LiDAR or FMCW Lidar scanners having polygonal mirrors, the multiplane scanner has a light transmitter for transmitting a light beam into a monitored zone, a light receiver for receiving the light beam reflected by objects in the monitored zone, an evaluation unit for evaluating a received signal of the light receiver, and a polygonal mirror wheel rotatable about a first axis of rotation and having a plurality of mirror facets arranged in ring form. The mirror facets are tilted at least partly with respect to one another with respect to the first axis of rotation and the multiplane scanner can therefore scan an angular section of the monitored zone multiple times at different heights on a revolution of the mirror unit. A beam deflection unit for setting an angle of incidence of the light beam on the mirror facets is arranged between the light transmitter and the polygonal mirror wheel.

The invention now starts from the basic idea that a control unit is configured to receive a desired trajectory for the light beam in the monitored zone and to control the polygonal mirror wheel and the beam deflection unit such that the light beam scans the monitored zone along the desired trajectory.

The invention has the advantage that a multiplane scanner or multilayer scanner can be provided having freely specifiable scan planes in which the light beam can scan the monitored zone along a substantially freely specifiable trajectory. “Substantially” here means that the possibility of specifying the trajectory is only restricted by boundary conditions such as the number and size of the mirror facets and the beam deflection by the beam deflection unit that is maximally possible in time and space. The invention thus differs from the prior art in which the scan planes are fixedly defined by the system design and are, for example, optimized for a constant angular resolution.

The control unit is preferably configured to determine control parameters for the polygonal mirror wheel and the beam deflection unit based on the received desired trajectory. A particularly precise scanning of the monitored zone along the desired trajectory is thereby made possible.

The control unit can preferably be configured to receive the desired trajectory of the light beam in the monitored zone by a user input. A user can, for example, define the desired trajectories in the monitored zone at an input unit that communicates this information to the control unit. Such a user input can take place on a putting into operation of the sensor, for example. Alternatively or additionally, an adaptation of desired trajectories on a situation by situation basis can also take place, based on a distance of the multiplane scanner from a detected object, for example. The terms control unit and input unit are to be understood as functional blocks here that can be implemented separately or also together as hardware or, for example, also as a component of a superior control and evaluation unit of the sensor.

The input of a desired trajectory can in particular take place by specifying scan planes in the monitored zone or scan lines on an imaginary target plane in the monitored zone. The imaginary target plane can here preferably be a plane that is aligned in parallel with the axis of rotation of the polygonal mirror wheel and that is arranged at a defined distance from the multiplane scanner.

An alignment of the monitored zone can be corrected after an installation of the multiplane scanner by specifying a desired trajectory, for example. A mechanical realignment of the scanner can thereby be dispensed with. This is in particular of advantage when the scanner is fastened at points that are difficult to access (for example at cranes, masts, or in deep shafts) or if the installation site of the scanner changes over the course of time.

A desired trajectory specification for the light beam in the monitored zone can take place, for example, such that the asymmetry initially explained with reference to FIG. 5 is eliminated, that is a multiplane scanner or a multilayer scanner having a constant angular offset can be provided. The additional planes can therefore have a constant deviation from the middle plane independent of the rotational position in a polar observation. A complete compensation does not have to be achieved here since a reduction of the asymmetry already improves the multiplane scanner. A complete compensation is, however, at least possible at a measurement distance, that is at a defined spacing from the sensor. With reference to FIG. 5, parallel scan lines can thus in particular be generated on a target plane in the monitored zone. The beam deflection unit deflects the light beam onto the mirror facets here such that the effect of the angle of incidence of the light beam on the mirror facets varying in the course of the rotational movement is compensated, the light beam in the monitored zone therefore scans the specified desired trajectory.

The beam deflection unit can be formed as a rotating mirror rotatable about a second axis of rotation, for example as a galvanometer mirror, with the second axis of rotation not being aligned in parallel with, preferably perpendicular to the first axis of rotation of the polygonal mirror wheel. A vertical deflection can thereby be generated in the monitored zone, that is a deflection perpendicular to the deflection of the light beam by the polygonal mirror wheel. Alternatively, the deflection element can be formed as an MEMS mirror or as a so-called phased array, that is can deflect the light beam by phase modulation.

The beam deflection unit can be configured to set a position of incidence of the light beam on the mirror facets in addition to the angle of incidence of the light beam. An even better adaptation of the trajectory of the light beam in the monitored zone to the specified desired trajectory is thereby possible.

The control unit can preferably be configured to determine the control parameters for the polygonal mirror wheel and the beam deflection unit on a model basis, with a calculation model being able to be stored in the control unit by which optical paths of the light beam in the monitored zone can be calculated or simulated in dependence on the angle of rotation of the polygonal mirror wheel. Starting from the received desired trajectory, control parameters for the beam deflection can then be determined by the beam deflection unit, for example the setting position of a galvanometer mirror, that are required so that the light beam scans the monitored zone along the desired trajectory.

The calculation model can be based on known methods of geometrical optics such as ray tracing and can in particular take account of the influence of a transmission and/or reception optics of the multiplane scanner on the optical paths of the light beam in addition to the beam deflections by the polygonal mirror wheel.

The calculation of the control parameters can take place recursively via symbolic/algebraic calculation starting from an assumed object in the monitored zone or the above-named target plane. Alternatively or additionally, a forward calculation can also take place, with the optical path toward the polygonal wheel mirror and further to an assumed object or to the target plane in the monitored zone being calculated starting from a variable deflection of the light beam by the beam deflection unit. An iterative search algorithm can systematically analyze different deflections of the light beam by the beam deflection unit and can numerically approach the desired trajectory. The use of a calculation model has the advantage that the control parameters can be calculated with respect to the run time, with the control unit preferably being able to have a real time calculator for calculating the control parameters with respect to the run time. This subsequently permits any desired specifications of the beam deflection. If only one constellation or certain constellations are provided, the calculation can also be carried out in advance and lookup tables can be prepared that can be accessed in operation of the multiplane scanner.

The control of the polygonal mirror wheel and the beam deflection unit can preferably take place via a cascaded regulation by regulators for the polygonal mirror wheel and the beam deflection unit, with the control unit preferably being able to be configured to regulate a rate of rotation of the polygonal mirror wheel, in particular independently of a control of further components of the multiplane scanner. The beam deflection unit receives its control parameters from the above-described calculation model that receives a position of the polygonal mirror wheel and calculates the control parameters for the beam deflection unit using the desired trajectory. The beam deflection unit is thereby always synchronized with the position of the polygonal mirror wheel. The position of the polygonal mirror wheel can be provided, for example, via a first encoder that detects the angular position and/or angular speed or the rotational position and/or rate of rotation of the polygonal mirror wheel. If the beam deflection unit is designed as a rotating mirror, a second encoder can detect a rotational position of the rotating mirror.

The regulator of the beam deflection unit is preferably adapted to be faster than the regulator of the polygonal mirror wheel. A synchronization of the polygonal mirror wheel and the beam deflection unit can thereby be ensured. A time delay of the control loop of the beam deflection unit can be taken into account in the calculation model, for example by a physical model of the beam deflection unit and its control loop. In this respect, in particular further measured variables such as regulation errors, current and voltage at the galvanometer mirror, or also data of the acceleration sensor (feedforward control) at the multiplane scanner can also be taken into account.

The control unit can preferably be configured to receive a distance of the multiplane scanner from a target zone in the monitored zone and to control the polygonal mirror wheel and the beam deflection unit using the distance of the multiplane scanner from the target zone in the monitored zone. Distance-dependent distortion of the trajectory can thereby be further compensated.

The multiplane scanner can have an acceleration sensor, with the control unit being configured to receive data of the acceleration sensor and to control the polygonal mirror wheel and the beam deflection unit using the data of the acceleration sensor. Deviations of the trajectory due to the multiplane scanner's own rotation can be reduced, for example, by the taking into account of the data of the acceleration sensor.

The control unit can be configured to determine intermediate values for encoder signals of the polygonal mirror wheel and/or of the deflection unit by temporal interpolation and to generate homogenized control parameters for the deflection element, for example setting movements for the rotatable mirror.

The evaluation unit is preferably configured to rectify the received signals of the light receiver using position errors of the polygonal mirror wheel and/or of the beam deflection unit.

The polygonal mirror wheel can preferably be controlled by the control unit such that it rotated about the first axis of rotation at a constant speed. A temporally uniform horizontal deflection of the light beam in the monitored zone is thus generated.

In a further embodiment of the invention, the polygonal mirror wheel can have at least one tilt element to vary the tilt of at least one mirror facet relative to the axis of rotation of the polygonal mirror wheel. The vertical scan range of the scanner can thus be further increased. In an embodiment of this aspect, the inclination of the mirror facets can be varied in synchronization with the rotational movement of the polygonal mirror wheel. A further degree of freedom to influence the trajectory of the light beam in the monitored zone thus results.

The light transmitter of the multiplane scanner can be configured to transmit a plurality of light beams spaced apart from one another so that a faster or denser scanning of the monitored zone is possible. Since a scan of the monitored zone along the desired trajectory is only possible for one of the plurality of light beams, the control unit can be configured to control the polygonal mirror wheel and the beam deflection unit such that a mean deviation of the light beams from the desired trajectory Is minimized.

The sensor in accordance with the invention can be used in a plurality of systems and applications, for example in the initially named automated guided vehicles (AGVs) or in the monitoring and classification of vehicles, for example on highways or at automatic detection points (toll bridges). Further application areas can, for example, be the detection of aircraft on the apron of an airport or the detection of ships and/or their cargoes in a port. On the detection of ships and their cargoes in ports, an adaptation of the monitored zones to a (tide dependent) water level can take place by the possibility of specifying a desired trajectory.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

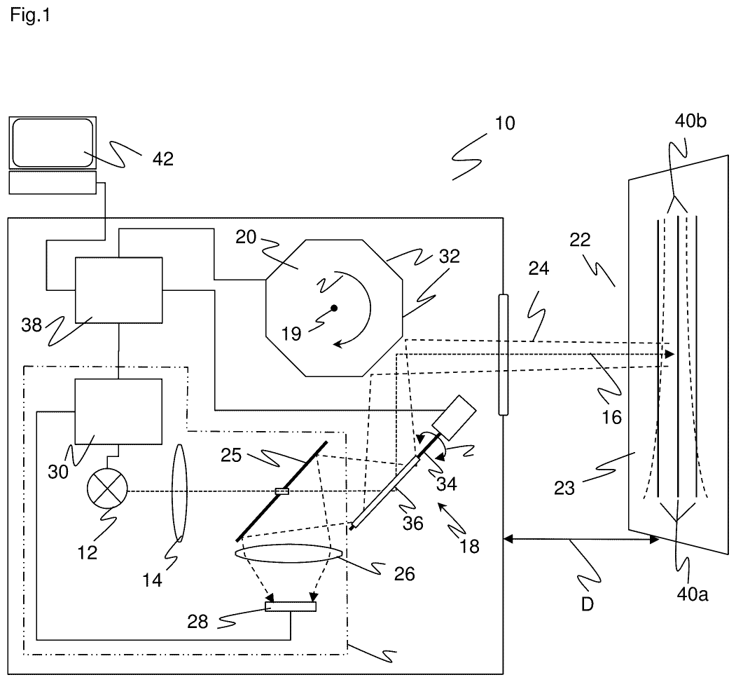

FIG. 1 a block diagram of an embodiment of a multiplane scanner in accordance with the invention;

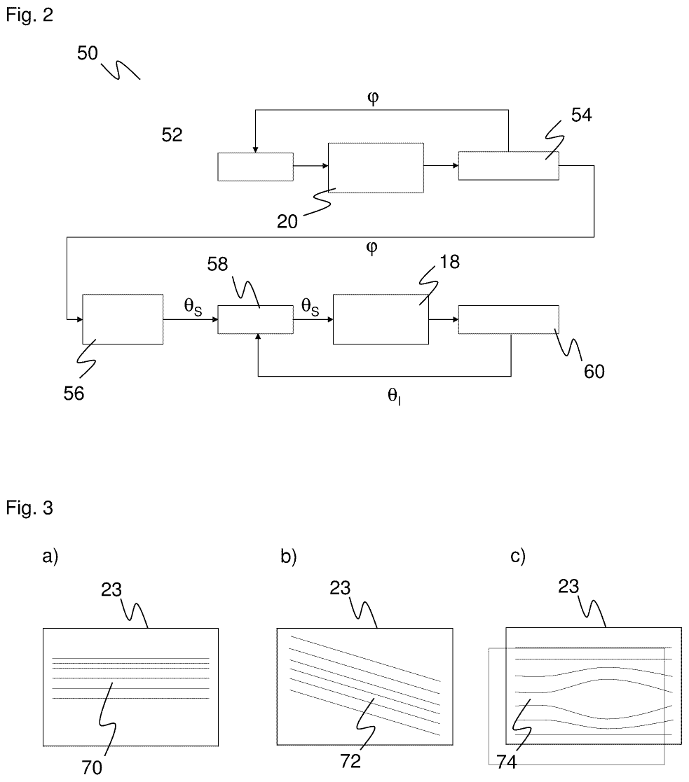

FIG. 2 a schematic representation of an exemplary regulation of a multiplane scanner in accordance with the invention;

FIG. 3 exemplary trajectories that can be scanned on a target plane using a multiplane scanner in accordance with the invention;

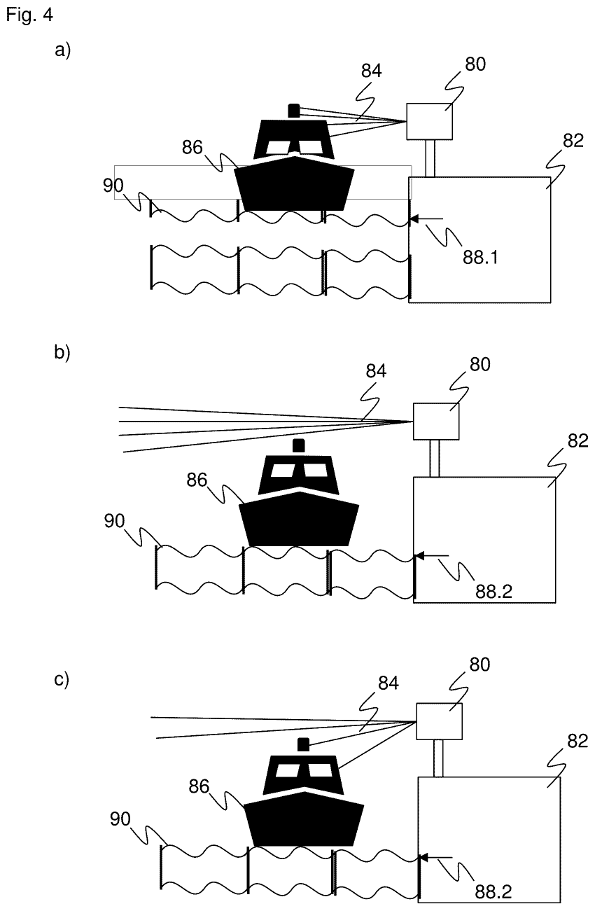

FIG. 4 a schematic representation of a use of a multiplane scanner in accordance with the invention for detecting a ship; and

FIG. 5 an asymmetrical extent of the vertical offset of scan lines in dependence on the angle of rotation with a conventional multiplane scanner.

FIG. 1 shows a block diagram of a multiplane scanner 10. A light transmitter 12, for example a laser diode or an LED, generates a light beam 16 with the aid of a transmission optics 14 that is deflected a first time via a beam deflection unit 18 and a second time via a polygonal mirror wheel 20 rotating about a first axis of rotation 19 and is then transmitted into a monitored zone 22.

If the light beam 16 is incident on an object in the monitored zone 22, a reflected light beam 24 returns to the multiplane scanner, is again deflected at the polygonal mirror wheel 20 and the beam deflection unit 28, and is then imaged on a light receiver 28 via a beam splitter 25 and a reception optics 26. No distinction is made linguistically here between reflection and the diffuse remission that occurs substantially more frequently at the object. The beam splitter 25 is configured either as a beam splitter or as an aperture mirror. A biaxial design would also be possible. The light beam 16 and the received light 24 are then substantially arranged in parallel with one another with a small distance in the direction of the axis of rotation of the polygonal mirror wheel 20.

A received signal generated by the light receiver 28 is transferred to an evaluation unit 30. It is recognized there, for example, whether an object has been scanned at all and, on a detection of an object, its distance is determined, preferably using a time of flight or FMCW process.

The polygonal mirror wheel 20 is an example for a rotatable mirror unit having a plurality of mirror facets 32 at its outer circumference. The number of mirror facets 32 corresponds to the scan angular range that is the larger, the fewer mirror facets 32 are provided. The number of eight mirror facets 32 is accordingly not fixed in any manner, but more or fewer mirror facets 32 can equally be provided. The base surface also does not have to be a regular polygon, but it is in principle also possible to provide mirror facets 32 of different lengths.

Although not recognizable in the plan view of FIG. 1, the mirror facets 32 are tilted with respect to one another. This does not mean the tilt in the horizontal direction predefined by the nature of the polygon, but rather an additional individual tilt in the vertical direction. The surfaces of the mirror facts 32 are therefore not aligned in parallel with the center axis of the polygonal mirror wheel that also forms the first axis of rotation 19 in the embodiment shown, but is in contrast individually tilted by at least some degrees. Depending on the horizontal inclination of the mirror facet 32 respectively impacted by the light beam 16 of the light transmitter 12, a different plane is therefore scanned over an angular range corresponding to the horizontal extent of the mirror facet 32 and the multiplane scan is therefore produced, indicated by trajectories 40a, 40b of the light beam 16 that would result on a target plane perpendicular to the plane of the drawing in the monitored zone 22; the target plane represents a target zone 32 in the monitored zone that is located at a distance D from the multiplane scanner 10. The respective inclination of the mirror facets is preferably individual, but a plurality of mirror facets 32 of the same inclination are also conceivable; the corresponding plane is then scanned multiple times per revolution of the polygonal mirror wheel 20.

The evaluation unit 30 is aware of the respective rotational position □ of the polygonal mirror wheel 20, for example via a first encoder that like the drive for the rotation is not shown in FIG. 1 and is known per se. The rotational position □ of the polygonal mirror wheel 20 not only contains the information on the horizontal angle directly, but also indirectly via the vertical angle when the inclinations of the mirror facets 32 with respect to the first axis of rotation 19 are stored. The evaluation unit 30 is furthermore aware of the vertical angle at which the light beam 16 departs the beam deflection unit 18 in the direction of the polygonal mirror wheel 20. The beam deflection unit 18 in the present embodiment is designed as a rotating mirror 36, for example as a galvanometer mirror whose axis of rotation 34 is aligned perpendicular to the first axis of rotation 19 of the polygonal mirror wheel 20. The angle at which the light beam 16 departs the beam deflection unit 18 in the direction of the polygonal mirror wheel 20 here results via the rotational position □ of the rotating mirror 36 that is detected via a second encoder, likewise not shown. With knowledge of the rotational position □ of the polygonal mirror wheel 20 and of the rotational position □ of the rotating mirror 26, object positions or object contours are therefore detectable in three-dimensional spherical coordinates at a distance measured via a time of flight process.

The polygonal mirror wheel 20 and the beam deflection unit 18 are controlled by a control unit 38. The control unit 38 is configured to receive a desired trajectory 40a for the light beam 16 in the monitored zone 22, for example by a user input via an input unit 42.

As explained in the introduction with reference to FIG. 5, only one mirror facet 32 generates a real scan plane, that is called a middle or horizontal plane independently of its actual position, without any vertical inclination with respect to the first axis of rotation 19 (tilt=0°). The other planes are strictly speaking not planes in the geometrical sense despite their designation selected here, which results in a distorted trajectory 40b of the light beam 16 in the monitored zone 22 that differs from the specified desired trajectory 40a.

To compensate this effect, the control unit 38 is configured to control the polygonal mirror wheel 20 and the beam deflection unit 18 such that the light beam scans the monitored zone along the desired trajectory 40a.

For this purpose, the control unit 38 can first adjust a rotational speed of the polygonal mirror wheel 20 and keep it constant. The control unit 38 is then furthermore configured to determine the rotational position □ of the polygonal mirror wheel 20 using a calculation model, said rotational position □ being necessary to scan the desired trajectory 40 and to control the rotating mirror 36 accordingly. The rotating mirror 36 is thereby always synchronized with the polygonal mirror wheel 20 and the light beam scans the desired trajectory 40a.

The basic design of the multiplane scanner 10 in accordance with FIG. 1 is only to be understood as an example. The transmission path and reception path can thus also be differently separated than by the shown beam splitter 25 or the polygonal mirror wheel 20 can be differently arranged and oriented with respect to the transmission path and to the reception path.

FIG. 2 shows a schematic representation of an exemplary regulation 50 of the multiplane scanner 10 by the control unit 38. A first regulator 52 is configured to adjust the rotational speed of the polygonal mirror wheel 20 and keep it constant in a first step The rotational speed is produced by the specification of a speed at which the light beam 16 should scan the monitored zone 22. A first encoder 54 determines the rotational position [symbol] of the polygonal mirror wheel 20 and forwards it to the first regulator 52 that can stabilize the speed of the polygonal mirror wheel 20 based on the determined rotational position [symbol] .

The rotational position [symbol] of the polygonal mirror wheel 20 is additionally forwarded to a calculation model 56 that calculates the angle of incidence of the light beam 16 on the mirror facets 32 and, from this, a control parameter for the deflection unit 18, that is a desired rotational position [symbol] _{S} of the rotating mirror 36, using the rotational position [symbol] of the polygonal mirror wheel 20 and the specified desired trajectory 40a. The desired rotational position [symbol] _{S} is forwarded to a second regulator 58 that adjusts the deflection unit 18 or the rotating mirror 36 accordingly. The deflection unit 18 or the rotating mirror 36 is thereby synchronized with the polygonal mirror wheel 20. A second encoder 60 determines an actual rotational position [symbol] _{I} of the rotating mirror 36 and returns it to the second regulator 58 that corrects a deviation from the desired rotational position [symbol] _{S} of the rotating mirror 36 based on the determined actual rotational position [symbol] _{I}.

The second regulator 58 of the deflection unit 18 or of the rotating mirror 36 has to be designed as faster than the first regulator 52 of the polygonal mirror wheel so that a synchronization is ensured. The time delay of the regulation of the deflection unit 18 has to be taken into account depending on the regulator speed in the calculation model 56. A physical model of the deflection unit 18 and of its regulator 58 can also be included for this purpose. In this respect, further measured variables such as regulation errors, current and voltage at the rotating mirror 36, or also data of an acceleration sensor (feedforward control) at the multiplane scanner 10 can also be taken into account.

FIG. 3 shows different exemplary trajectories that can be scanned on a target plane 23 in the monitored zone 22 using a multiplane scanner 10 in accordance with the invention. Since the trajectory can be regulated substantially freely, all trajectory forms are theoretically possible that take account of a monotonically progressing rotational position [symbol] of the polygonal mirror wheel 20.

Horizontal trajectories 70 that extend substantially in parallel and that have an increased density in the upper region are shown in a). Scan lines having locally different densities can therefore be generated.

As shown in b), inclined trajectories 72 are also possible so that an alignment correction is possible, for example with a tilted multiplane scanner, that can also be corrected in the alignment of its monitored zone at any time after the assembly.

Freely defined trajectories 74 are shown in c) by which regions in the monitored zone can be avoided by the light beam, for example light sensitive zones or regions in which no data pickup is necessary.

FIG. 4 shows a schematic representation of a use of a multiplane scanner 80 in accordance with the invention that is arranged at a quay 82 of a port. In a), the light beams 84 transmitted by the multiplane scanner 80 detect a ship 86 that lies at the quay 82 at a first level 88.1 of the water surface 90.

If the water surface 90 falls to a second level 88.2, as shown in b), for example due to a tidal range, the light beams 84 transmitted by the multiplane scanner 80 would miss the ship 86 and could in particular no longer reliably detect is in a near zone of the quay 82.

As shown in c), the light beams 84 transmitted by the multiplane scanner can be fanned out by an adaptation of the desired trajectories such that the ship 86 can be detected without mechanically changing an alignment of the multiplane scanner 80. The fanning out of the light beams 84 additionally has the advantage that objects (not shown) also far remote from the quay 82 can still be detected, whereas only the near zone of the quay 82 would be detected on a mechanical tilting of the total multiplane scanner 80 without a fanning out of the light beams 84.

1. A multiplane scanner having alight transmitter for transmitting alight beam into a monitored zone, having a light receiver for receiving the light beam reflected by objects in the monitored zone, having an evaluation unit for evaluating a received signal of the light receiver, and having a polygonal mirror wheel that is rotatable about a first axis of rotation for a periodic deflection of the light beam and that has a plurality of mirror facets arranged in ring form and tilted at least partly with respect to one another with respect to the first axis of rotation to thus scan an angular section of the monitored zone multiple times at different heights as the monitored zone per revolution of the polygonal mirror wheel, that is a plurality of scan planes disposed above one another, wherein a beam deflection unit for setting an angle of incidence of the light beam on the mirror facets is arranged between the light transmitter and the polygonal mirror wheel,
wherein a control unit is configured to receive a desired trajectory for the light beam in the monitored zone and to control the polygonal mirror wheel and the beam deflection unit such that the light beam scans the monitored zone along the desired trajectory.

2. The multiplane scanner in accordance with claim 1, wherein the control unit is configured to determine control parameters for the polygonal mirror wheel and the beam deflection unit based on the received desired trajectory.

3. The multiplane scanner in accordance with claim 1, wherein the multiplane scanner has an input unit for inputting the desired trajectory and the control unit is configured to receive the desired trajectory from the input unit.

4. The multiplane scanner in accordance with claim 2, wherein the control unit is configured to determine the control parameters for the polygonal mirror wheel and the beam deflection unit on a model basis.

5. The multiplane scanner in accordance with claim 1, wherein the multiplane scanner has a first regulator for regulating the polygonal mirror wheel and a second regulator for regulating the beam deflection unit.

6. The multiplane scanner in accordance with claim 5, wherein the second regulator is designed as faster than the first regulator.

7. The multiplane scanner in accordance with claim 1, wherein the control unit is configured to receive a distance of the multiplane scanner from a target zone in the monitored zone and to control the polygonal mirror wheel and the beam deflection unit using the distance of the multiplane scanner from the target zone in the monitored zone.

8. The multiplane scanner in accordance with claim 1, wherein the multiplane scanner has an acceleration sensor and the control unit is configured to receive data of the acceleration sensor and to control the polygonal mirror wheel and the beam deflection unit using the data of the acceleration sensor.

9. The multiplane scanner in accordance with claim 1, wherein the beam deflection unit is a rotating mirror rotatable about a second axis of rotation, with the second axis of rotation not being aligned in parallel with the first axis of rotation.

10. The multiplane scanner in accordance with claim 9, wherein the rotating mirror is a galvanometer mirror.

11. The multiplane scanner in accordance with claim 1, wherein at least one mirror facet has a tilt element to tilt the mirror facet settably with respect to the first axis of rotation and the control unit is configured to control the tilt element.

12. A method of detecting objects using a multiplane scanner in which a light beam is transmitted into a monitored zone and is received again and evaluated after reflection at an object in the monitored zone, wherein the monitored zone is cyclically scanned in that the light beam is deflected at a polygonal mirror wheel rotatable about a first axis of rotation and having a plurality of mirror facets arranged in ring form and tilted at least partly with respect to one another to thus scan an angular section multiple times at different heights in the monitored zone per revolution of the mirror unit, that is a plurality of planes disposed above one another, with a beam deflection unit arranged between the light transmitter and the polygonal mirror wheel setting an angle of incidence of the light beam on the mirror facets,
wherein a control unit receives a desired trajectory for the light beam in the monitored zone and controls the polygonal mirror wheel and the beam deflection unit such that the light beam scans the monitored zone along the desired trajectory.

13. The method in in accordance with claim 12, wherein the control unit determines control parameters for the polygonal mirror wheel and the beam deflection unit using the desired trajectory.

14. The method in accordance with claim 13, wherein the control unit calculates optical paths of the light beam in the monitored zone in dependence on a rotational position of the polygonal mirror wheel.

15. The method in accordance with claim 13, wherein the beam deflection unit has a rotating mirror that sets the angle of incidence of the light beam on the mirror facets and the control unit calculates a rotational position of the rotating mirror in dependence on a rotational position of the polygonal mirror wheel.

16. The method in accordance with claim 13, wherein the control unit determines the control parameters for the polygonal mirror wheel and the beam deflection unit using a distance of the multiplane scanner from the target zone in the monitored zone.
